(19) United States
(12) Patent Application Publication
(10) Pub. No.: US 2009/0283661 A1
(43) Pub. Date: Nov. 19, 2009

(54) MONITOR ALLOWING POSITION ADJUSTMENT OF AUDIO AND VIDEO RETRIEVING UNITS PROVIDED THEREON

(76) Inventors: James CHU, Zhonghe city (TW); H. C. HO, Zhonghe City (TW); Sho-chaug SUN, Zhonghe City (TW)

Correspondence Address: LUCAS & MERCANTI, LLP, 475 PARK AVENUE SOUTH, 15TH FLOOR, NEW YORK, NY, 10016, US

(21) Appl. No.: 12/121,377

(22) Filed: May 15, 2008

(51) Int. Cl. F16M 11/00

(52) U.S. Cl. 248/678

(57) ABSTRACT

A monitor includes a display mechanism having a display screen located on a front side thereof, and a video retrieving unit and an audio retrieving unit located at predetermined positions in the vicinity of the display screen; an adjusting mechanism connected to and located behind the display mechanism, and including a rotating unit connected to a rear lower portion of the display mechanism, and an elevating unit connected at an upper end to the rotating unit; and abase being fixedly connected to a lower end of the adjusting mechanism and provided at a bottom surface with a rotary disc. With these arrangements, the video and audio retrieving units of the display mechanism may be adjusted to a desired vertical height, inclination angle, and/or horizontal angle via the adjusting mechanism and the rotary disc of the base.

### FIELD OF THE INVENTION

The present invention relates to a monitor allowing position adjustment of audio and video retrieving units provided thereon, and more particularly to a monitor that allows audio and video retrieving units provided thereon to be adjusted to desired vertical height, inclination angle, and/or horizontal angle according to a user's actual need.

### BACKGROUND OF THE INVENTION

A monitor electrically connected to a computer normally could only output related operating platform and desired images. When a user desires to link to a remote user for the purpose of video communication, he or she must have a video retrieving unit externally connected to the computer. Since the video retrieving unit is externally connected to the computer, the user has to troublesomely find a suitable place for locating the video retrieving unit. Moreover, the user also has to prepare a space for storing the video retrieving unit when the same is not in use.

To eliminate the above-mentioned locating and storing problem, there is developed a monitor with a video retrieving unit fixedly mounted to a top of the monitor. However, the video retrieving unit fixedly mounted to the top of the monitor could not be conveniently adjusted to a position best for retrieving video signals. To overcome the problems in the video retrieving unit externally connected to or fixedly mounted on the monitor so that the video retrieving unit is more conveniently for use, there is further developed a rotatable video retrieving unit movably mounted on a top of a monitor via a case, so as to achieve the purpose of adjusting the video retrieving unit to a desired angular position relative to the monitor.

The above-mentioned case only allows the video retrieving unit to be tilted forward and backward and accordingly adjusted to a desired angle of inclination relative to the monitor, but not to be horizontally swung to a desired horizontal angle. Therefore, the position adjustment of the video retrieving unit in practical use thereof is still subjected to a lot of limitation.

### SUMMARY OF THE INVENTION

A primary object of the present invention is to provide a monitor that allows a user to adjust the vertical height, the inclination angle, and/or the horizontal angle of an audio and a video retrieving unit provided on the monitor according to the user's actual need.

To achieve the above and other objects, the monitor according to the present invention includes a display mechanism having a display screen located on a front side thereof, and a video retrieving unit and an audio retrieving unit located at predetermined positions in the vicinity of the display screen; an adjusting mechanism being connected to and located behind the display mechanism, and including a rotating unit connected to a rear lower portion of the display mechanism, and an elevating unit connected at an upper end to the rotating unit; and a base being fixedly connected to a lower end of the adjusting mechanism and provided at a bottom surface with a rotary disc. With these arrangements, the video and audio retrieving units of the display mechanism may be adjusted to a desired vertical height, inclination angle, and/or horizontal angle via the adjusting mechanism and the rotary disc of the base.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front view of a monitor according to the present invention;

FIG. 2 is a rear view of the monitor of FIG. 1;

FIG. 3 is a bottom view of the monitor of FIG. 1; and

FIG. 4 is a side view showing the monitor of the present invention in use.

### DETAILED DESCRIPTION OF THE PREFERRED EMBODIMENTS

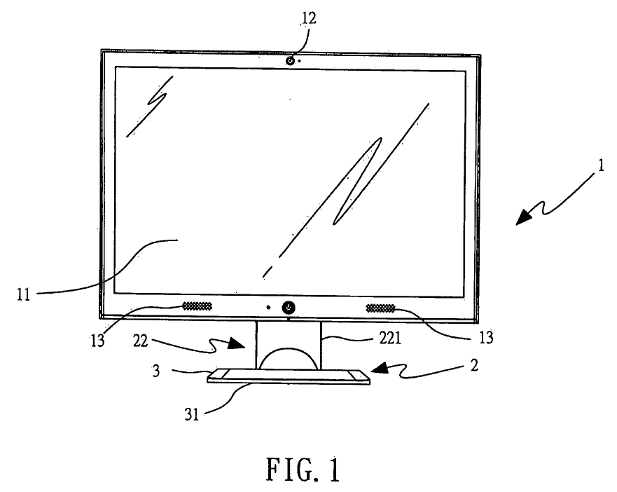

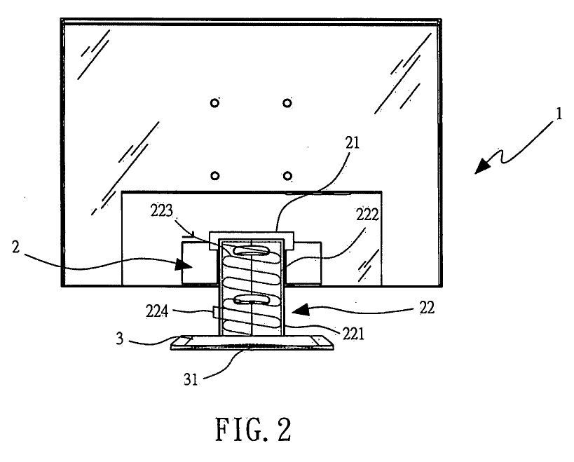

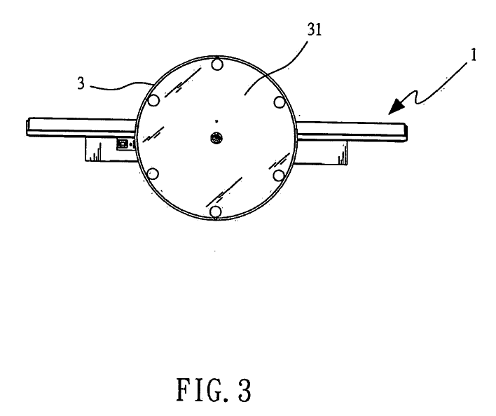

Please refer to FIGS. 1, 2, and 3 that are front, rear, and bottom views, respectively, of a monitor according to the present invention that allows position adjustment of audio and video retrieving units provided thereon. As shown, the monitor of the present invention includes a display mechanism 1, an adjusting mechanism 2, and a base 3.

The display mechanism 1 includes a display screen 11 located on a front side thereof, and a video retrieving unit 12 and an audio retrieving unit 13 located in the vicinity of the display screen 11.

The adjusting mechanism 2 is connected to and located behind the display mechanism 1, and includes a rotating unit 21 connected to a rear lower portion of the display mechanism 1, and an elevating unit 22 connected at an upper end to the rotating unit 21. The rotating unit 21 maybe a rotary shaft. The elevating unit 22 includes a first supporting section 221 connected at an upper end to the display mechanism 1 via the rotating unit 21, a second supporting section 222 upward extended into the first supporting section 221, an elastic element 223 mounted between the first and the second supporting section 221, 222 to push the first supporting section 221 upward relative to the second supporting section, and a pin 224 provided to one side of the second supporting section 222 to releasably interfere with the first supporting section 221.

The base 3 is fixedly connected to a lower end of the second supporting section 222 of the elevating unit 22, and is provided at a bottom surface with a rotary disc 31.

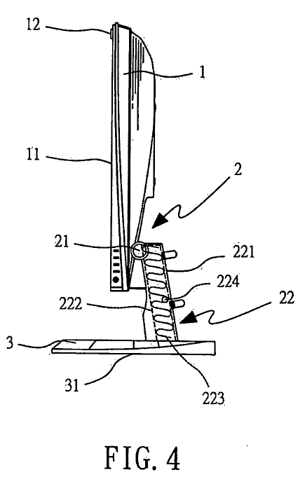

Please refer to FIG. 4 that shows the monitor of the present invention in use. To use the monitor of the present invention, first electrically connect the monitor to a computer (not shown), so that related operating platform and desired images are output via the display screen 11 of the display mechanism 1, and a user is allowed to use the video retrieving unit 12 and the audio retrieving unit 13 to link to and communicate with a remote user. When it is necessary to adjust the position of the display screen 11, the video retrieving unit 12, and the audio retrieving unit 13 in response to ambient light, the user's position relative to the display mechanism 1, etc., the user may use the adjusting mechanism 2 to conduct different adjustments, including the adjustments of the vertical height, the angle of inclination, and the horizontal angle of the display mechanism 1.

To conduct the vertical height adjustment, first loosen the pin 224 at one side of the second supporting section 222, so that the pin 224 does not interfere with the first supporting section 221. At this point, the elastic element 223 automatically pushes the first supporting section 221 upward relative to the second supporting section 222, bringing the display mechanism 1 connected to the first supporting section 1 to move upward. Therefore, the display screen 11, the video retrieving unit 12, and the audio retrieving unit 13 of the display mechanism 1 may be moved upward as desired. When the display mechanism 1 has been moved to a desired vertical height, the pin 224 is tightened again to interfere with the first supporting section 221, so that the first supporting section 221 and accordingly, the display mechanism I are locked to the desired vertical height.

When the display screen 11, the video retrieving unit 12, and the audio retrieving unit 13 of the display mechanism 1 have been adjusted to the desired vertical height as mentioned above, a user may turn the display mechanism 1 about the rotating unit 21 of the adjusting mechanism 2 relative to the first supporting section 221, so that the display mechanism 1 is tilted backward or forward to a desired angle of inclination. Further, the user may also swing the display mechanism 1 leftward or rightward relative to the rotary disc 31 of the base 3, so that the display screen 11, the video retrieving unit 12, and the audio retrieving unit 13 of the display mechanism 1 are adjusted to a desired horizontal angle.

With the above arrangements, the display mechanism 1 of the monitor according to the present invention may be adjusted via the adjusting mechanism 2 and the base 3 to different vertical heights, angles of inclination, and/or horizontal angles according to a user's actual need, making the monitor of the present invention more practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A monitor allowing position adjustment of video and audio retrieving units provided thereon, comprising:
a display mechanism including a display screen located on a front side thereof, and a video retrieving unit and an audio retrieving unit located at predetermined positions in the vicinity of the display screen;
an adjusting mechanism being connected to and located behind the display mechanism, and including a rotating unit connected to a rear lower portion of the display mechanism, and an elevating unit connected at an upper end to the rotating unit; and
a base being fixedly connected to a lower end of the elevating unit, and provided at a bottom surface with a rotary disc.

2. The monitor allowing position adjustment of video and audio retrieving units provided thereon as claimed in claim 1, wherein the rotating unit is a rotary shaft.

3. The monitor allowing position adjustment of video and audio retrieving units provided thereon as claimed in claim 1, wherein the elevating unit includes a first supporting section connected at an upper end to the display mechanism via the rotating unit, a second supporting section upward extended into the first supporting section, an elastic element mounted between the first and the second supporting section to push the first supporting section upward relative to the second supporting section, and a pin provided to one side of the second supporting section to releasably interfere with the first supporting section.
